(19) United States
(12) Patent Application Publication
(10) Pub. No.: US 2006/0053679 A1
(43) Pub. Date: Mar. 16, 2006

(54) Fishing lure

(76) Inventor: Carlo Eugenio Milanese, Prince Rupert (CA)

Correspondence Address: Fasken Martineau DuMoulin LLP, 2100 - 1075 West Georgia Street, Vancouver, BC, V6E 3G2, CA

(21) Appl. No.: 10/940,660

(22) Filed: Sep. 15, 2004

(51) Int. Cl. A01K 85/00

(52) U.S. Cl. 43/42.36

(57) ABSTRACT

A fishing lure is provided, comprising an elongated body having a bottom side, a front edge, a rear end, a first side and defining a passage from a first opening near said front end to a second opening on said first side, wherein said bottom side of said body angles upward at said front edge; two black tail members extending upwardly and downwardly respectively from said rear end; an eye positioned on said first side; a line passing through said passage, said line secured to said body towards said rear end by a pin; a first hook secured to said line near second opening; a second hook secured to the end of said line; and a patch positioned behind said eyes, said patch having outside edges, said outside edges being black and the inside portion of said being a reddish color; wherein said body curves gently on said first side; and wherein said body is generally silver colored and said front edge is red.

### BACKGROUND OF THE INVENTION

1. Field of the Invention

The present invention relates to generally to lures and other fishing tools, and more specifically to lures that mimic the behaviour of fish.

2. Description of the Related Art

Fishing lures are commonly used in sport fishing to attract fish such as salmon. The salmon, after biting the lure, becomes hooked and can then be brought aboard a boat or deck by the fisher. A number of different types of these lures are available in the art.

Canadian Patent No. 1,107,503 to Metzler et al discloses a salmon jig. The Metzler et al. jig is a single hooked jig with a curved elongated body. Other related art includes U.S. Pat. No. 2,796,693 to Gunterman; U.S. Pat. No. 4,142,318 to Morrell; U.S. Pat. No. 6,327,808 to Zascavage; and Canadian Patent No. 1,168,867 to Reid.

### BRIEF SUMMARY OF THE INVENTION

A fishing lure is provided, comprising an elongated body having a bottom side, a front edge, a rear end, and a first side, and having a passage defined from a first opening near said front end to a second opening on said first side, wherein said bottom side of said body angles upward at said front edge; two black tail members extend upwardly and downwardly respectively from said rear end; an eye is positioned on said first side; a line passes through said passage, said line secured to said body towards said rear end by a pin; a first hook secured to said line near the second opening; a second hook is secured to the end of said line; and a patch positioned behind said eyes, said patch having outside edges, said outside edges being black and an inside portion of said patch being a reddish color; wherein said body curves gently on said first side; and wherein said body is generally silver colored and said front edge is red.

### BRIEF DESCRIPTION OF THE DRAWINGS

FIG. 1 is a side view of a fishing lure according to the invention;

FIG. 2 is a top view thereof;

FIG. 3 is a bottom view thereof;

FIG. 4 is a perspective view thereof;

FIG. 5 is a side view of an alternative embodiment of the invention;

FIG. 6 is a top view thereof;

FIG. 7 is a bottom view thereof; and

FIG. 8 is a perspective view thereof.

### DETAILED DESCRIPTION OF THE INVENTION

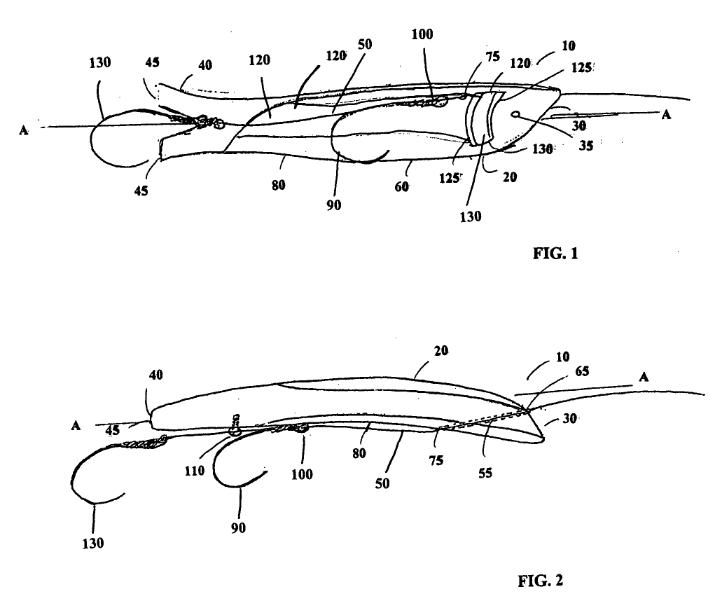

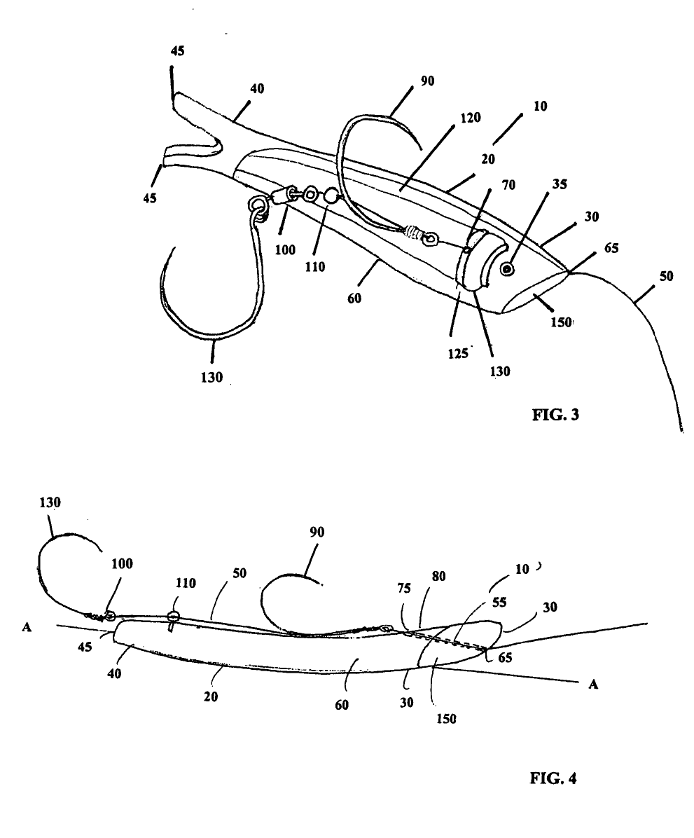

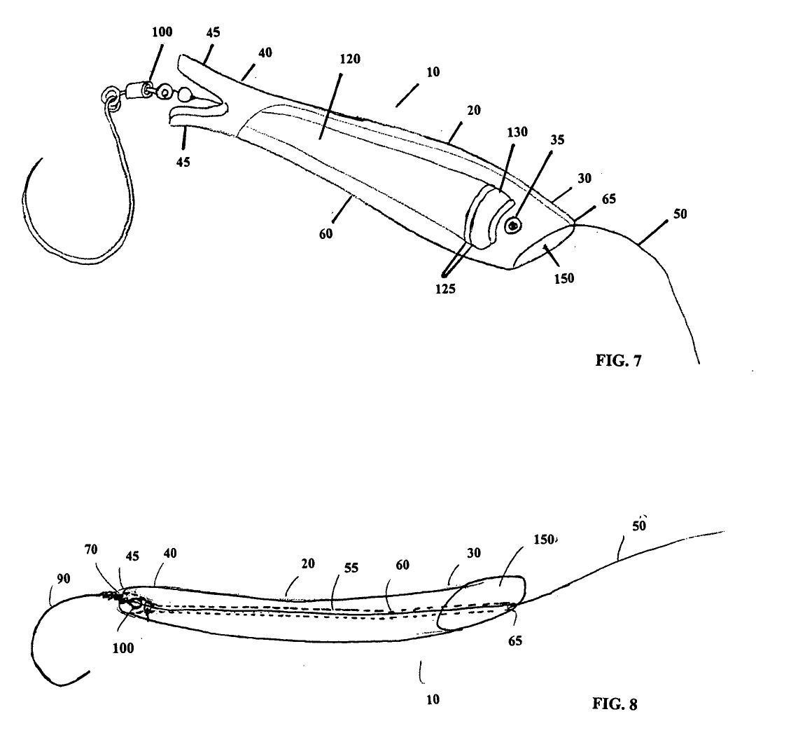

As seen in FIGS. 1 through 8, fishing lure 10 is generally fish shaped. More specifically, fishing lure 10 has an elongated body 20, a front end 30 that narrows from bottom side 60 and two tail members 45 at rear end 40. Body 20 has a gentle curve, of no more than 30° and may twist slightly (preferably no more than π/16 radians) around the A-A axis along its length. While the curve and twist described above are for a preferred embodiment, more generally the curve can range from 15° to 45° and the twist can be from nothing to π/8 radians.

The front end 30 of body 20 is narrower than the remainder of body 20 as bottom side 60 angles upward at front edge 150 to provide a shape similar to that of a juvenile herring. Eyes 35 are positioned on either side of body 20 near front end 30 and help cause front end 30 to appear as the head of a juvenile herring.

The rear end 40 of body 20 splits into two tail members 45. Tail members 45 extend from rear end 40 in an upward and downward direction, respectively, thereby forming the general shape of the tail of a juvenile herring.

As seen in FIGS. 1 through 4, in a preferred embodiment, line 50 is used to connect lure 10 to a fishing rod or other fishing instrument. Line 50 passes through body 20 at passage 55. Passage 55 has a first opening 65 near front end 30. Second opening 70 of passage 55 is on first side 80 of body 20. Line 50 is also secured to body 20 towards rear end 40 by means known in the art such as pin 110 and beads 100. A first hook 90 is secured to line 50, near second opening 70. Second hook 130 is secured at the end of line 50 and trails tail 45 when lure 10 is in use.

Line 50 is a fishing line as commonly used in the art.

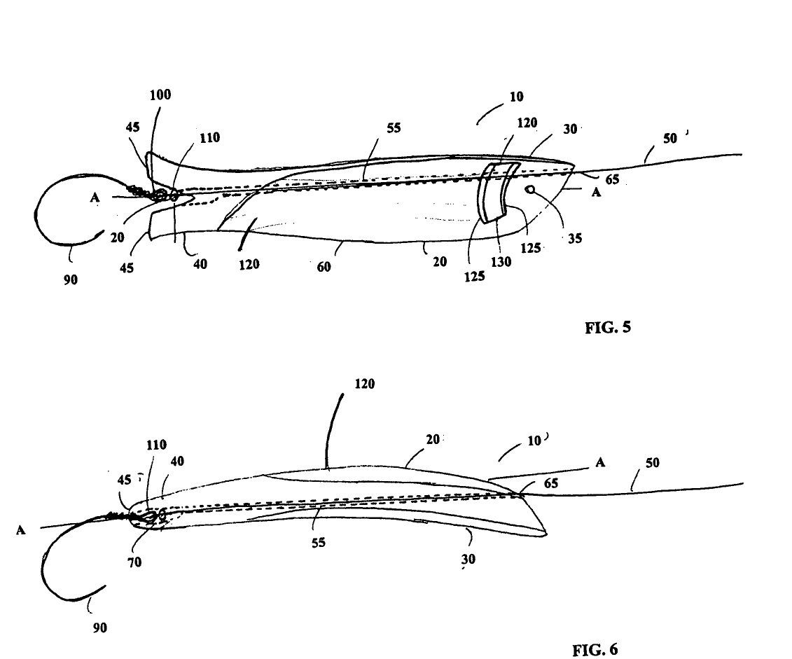

In an alternative embodiment, as seen in FIGS. 5 through 8, first opening 65 of passage 55 is at front end 30, and second opening 70 of passage 55 is at rear end 40, thereby allowing line 50 to pas through the length of body 20. First hook 90 is the placed at the end of line 50 so that it trails body 20 when lure 10 is in use.

Lure 10 is painted to resemble a herring. In particular patch 120 positioned on each side of lure 10 further causes lure 10 to resemble a wounded herring. Near the eyes 35 bars 125 of patch 120 are preferably black, green, blue or yellow and the inside portion 130 of patch 120 is preferably a reddish color. The remainder of patch 120 is preferably a silver color, and may be reflective. Tail members 45 of lure 10 are preferably painted black. The remainder of lure 10 is preferably painted in a silver or white color, and the top of lure 10 may be colored blue or green. The front edge 150 of lure 10 is preferably painted red.

Lure 10 is used as other lures in the art and is particularly suited for use in salmon fishing. When in the water, lure 10 will roll in a corkscrew pattern, imitating the pattern of movement of an injured herring. Lure 10 is typically between 2″ and 5″, and therefore in size, colour, and pattern of movement resembles an injured juvenile herring, making lure 10 a target for salmon.

Although the particular preferred embodiments of the invention have been disclosed in detail for illustrative purposes, it will be recognized that variations or modifications of the disclosed apparatus lie within the scope of the present invention

The invention claimed is:

1. A fishing lure comprising:
(a) an elongated body having a bottom side, a front edge, a rear end, a first side, and said body defining a passage from a first opening near said front end to a second opening on said first side;
(b) said bottom side of said body angling upwardly at said front edge;
(c) first and second black tail members extending upwardly and downwardly respectively from said rear end;
(d) an eye positioned on said first side;
(e) a line passes through said passage, said line secured to said body towards said rear end by a pin;
(f) a first hook secured to said line near second opening;
(g) a second hook secured to the end of said line; and
(h) a patch positioned behind said eyes, said patch having outside edges, said outside edges being black and the inside portion of said being a reddish color;
wherein said body curves gently on said first side; and
wherein said body is generally silver colored and said front edge is red.

2. The lure of claim 1 wherein said body twists along its length.

3. A fishing lure comprising:
(a) an elongated body having a bottom side, a front edge, a rear end, a first side and defining a passage from a first opening near said front edge to a second opening on said rear end;
(b) said bottom side of said body angles upward at said front edge;
(c) two black tail members extending upwardly and downwardly respectively from said rear end;
(d) an eye positioned on said first side;
(e) a line passes through said passage, said line secured to said body towards said rear end by a pin;
(f) a first hook secured to said line near said rear end; and
(h) a patch positioned behind said eyes, said patch having outside edges, said outside edges being black and the inside portion of said being a reddish color;
wherein said body curves gently on said first side; and
wherein said body is generally silver colored and said front edge is red.
